(19) United States
(12) Patent Application Publication
(10) Pub. No.: US 2006/0124416 A1
(43) Pub. Date: Jun. 15, 2006

(54) Method for regulating hydraulic resistance of a shock absorber during the operation thereof

(76) Inventor: Victor H Pereverzev, Dnepropetrovsk (UA)

Correspondence Address: FOLEY & LARDNER LLP, 777 EAST WISCONSIN AVENUE, SUITE 3800, MILWAUKEE, WI, 53202-5308, US

(21) Appl. No.: 10/543,041

(22) PCT Filed: Oct. 1, 2003
(86) PCT No.: PCT/UA03/00033

§ 371 Date: Jan. 20, 2006

(30) Foreign Application Priority Data
Jun. 6, 2003 (UA) 2003065259
Jan. 21, 2003 (UA) 2003010548

(51) Int. Cl. F16F 9/34

(52) U.S. Cl. 188/322.13; 188/313; 188/316

(57) ABSTRACT

The invention relates to transport vehicle engineering, in particular to shock absorbing devices for a suspension and can be used for front and rear vehicle shock absorbers and other transport means. The aim of said invention is to improve the operational reliability of a shock absorber service reliability, stability and comfort level of a motor vehicle during the travel thereof in difficult road conditions by means of a novel method for regulating the hydraulic resistance and, thereby the rigidity of said shock absorber during the operation thereof in different road conditions and in relation to the running weight of the vehicle.

### FIELD OF THE INVENTION

The invention relates to transport vehicle engineering, in particular to shock absorbing devices for a suspension and can be used for front and rear vehicle shock absorbers and other transport means.

### PRIOR ART

In the known methods hydraulic resistance of shock absorbers is regulated by means of regulating devices with fixed positions and external switching device. For example, in Bilstein shock absorbers rigidity is regulated by means of rotation of a roller which passes through a rod and either opens or closes piston capacity in one or other direction having fixed rigidity positions. The disadvantage of the known methods is that the regulating device can set only certain rigidity level which does not change during the operation of a shock absorber and, the consequences are:

low operational reliability of a motor vehicle during the travel thereof in washboard road constructions;

shaking, shocks and discomfort at mild and high speeds;

instability and poor motor vehicle handling in the roads with high frequency of vibrations.

### SUMMARY OF THE INVENTION

The aim of the said invention is to improve the operational reliability of a shock absorber, stability and comfort level of a motor vehicle during the travel thereof in difficult road conditions by means of a novel method for regulating the hydraulic resistance and, thereby the rigidity of said shock absorber during the operation thereof in different road conditions and in relation to the running weight of the vehicle.

According to the present invention engineering result is achieved by means of that in the method for regulating the hydraulic resistance of a shock absorber during the operation thereof, which includes forced flow of hydraulic fluid through the small open flow areas from the blind side towards the rod end and the other way, wherein open flow areas are created with varying capacity that is achieved with the use of mutually travelling metering components and is changed through variation of hydraulic pressure differences at the blind side and the rod end that are caused by variation of the load at the shock absorber.

In this connection hydraulic resistance and, consequently, rigidity of a shock absorber operation increases or decreases in relation to increase or decrease of pressure difference at the blind side and the rod end of the shock absorber. Increase of pressure difference between the rod end and the blind side causes the increase of the hydraulic resistance force of the shock absorber, accordingly, as pressure difference decreases the hydraulic resistance force of the shock absorber decreases as well.

### BRIEF DESCRIPTION OF THE DRAWINGS

FIG. 1 is a general view of a shock absorber design which allows embodying the present method.

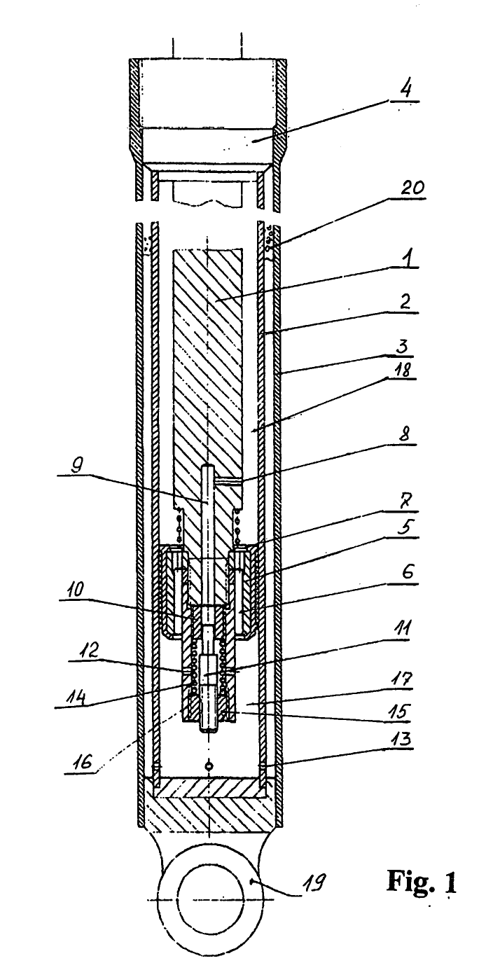

FIG. 2 is a scaled-up view of design of a unit with the regulating device.

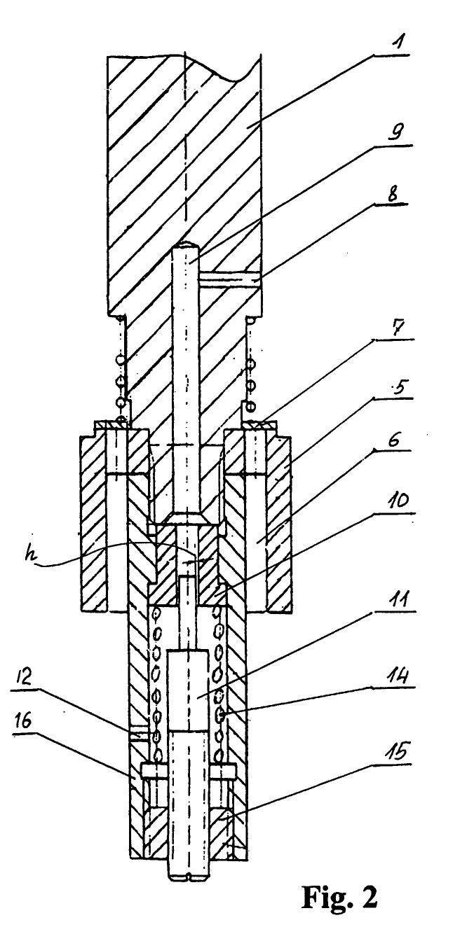

The shock absorber comprises a shock absorber rod 1, a working cylinder 2, an external tank 3, an upper monoblock unit 4 which serves as a rod guide and seal, a piston 5, a regulating piston 10 spring-loaded with spring 14, a regulating rod 11, a cylinder 16 with regulating nut 15. The regulating rod 11 is partially placed inside the regulating piston 10 with clearance h creating small open flow area of varying capacity which changes in relation to the depth of entering of the regulating rod 11 inside the regulating piston 10.

### DESCRIPTION OF THE PREFERRED EMBODIMENT

The embodiment of the method is as follows.

At compression stroke the piston 1 of the shock absorber moves down and the ear 19 moves up. In this connection hydraulic fluid moves from the blind side 17 to the rod end 18 through the channel 6 inside the piston 5 overcoming light resistance of the washer 7. An amount of the hydraulic fluid is displaced by the displacement volume of the shock absorber rod from the blind side through the channels 13 into the external tank 3 compressing gas 20 contained herein.

At decompression of the shock absorber (rebound stroke) the rod 1 of the shock absorber moves up and the ear 19 moves down. At that the channels 6 inside the piston 5 are lapped by the spring-loaded washer 7. The fluid flows through the metering opening 8 into the channel 9 inside the rod 1 of the shock absorber and flows to the regulating piston 10 where it encounters strong resistance flowing though the small open flow area—clearance h between internal walls of the regulating piston 10 and the regulating rod 11, then it flows through the channels 12 of the cylinder 16 into the blind side 17. An amount of the fluid is displaced by the gas 20 and flows through the channels 13 from the external tank 3 into the blind side 17. When load sharply increases the hydraulic fluid produces pressure over the regulating piston 10 which overcomes pressure of the spring 14 and causes the regulating piston 10 to move down. At that the regulating rod 11 moves deeper inside the regulating piston 10 thus increasing clearance between them and, consequently, decreasing capacity of the open flow area. At that the resistance to the fluid flow increases which results in increasing resistance of the shock absorber. Thus, the regulation of the hydraulic resistance of a shock absorber during the operation thereof occurs.

Consequently, application of the proposed method will provide the following advantages:

Zero damping lag of the shock absorbers, possibility of applying softer shock absorbers for high speed motor vehicles and securing motor vehicle handling at high loads on the shock absorber.

Shaking and discomfort are excluded at motor vehicle travel by grader or gravel roads. Motor vehicle handling is considerably improved on whatever road conditions.

By applying this method and changing capacity of the open flow areas the required parameters of rigidity and comfort level changes are achieved for various motor vehicles and other transport means.

The proposed arrangement is easily installed into the known designs of hydraulic and hydro-pneumatic shock absorbers of domestic and foreign motor vehicles.

1. The method for regulating the hydraulic resistance of a shock absorber during the operation thereof, which includes forced flow of hydraulic fluid through the small open flow areas from the blind side towards the rod end and the other way, characterized in that the open flow areas are created with varying capacity that is achieved with the use of mutually travelling metering components and is changed through effect of hydraulic pressure differences on the components at the blind side and the rod end so that the capacity decrease is caused by increase of the load at the shock absorber.
